(19) United States
(12) Patent Application Publication
(10) Pub. No.: US 2023/0394703 A1
(43) Pub. Date: Dec. 7, 2023

(54) POSITION ASSOCIATION SYSTEM, POSITION ASSOCIATION METHOD, AND POSITION ASSOCIATION PROGRAM

(71) Applicant: NEC Aerospace Systems, Ltd., Tokyo (JP)

(72) Inventors: Takahito Sakaue, Tokyo (JP); Yu Nureki, Tokyo (JP); Noriko Saito, Tokyo (JP)

(73) Assignee: NEC Aerospace Systems, Ltd., Tokyo (JP)

(21) Appl. No.: 18/203,332

(22) Filed: May 30, 2023

(30) Foreign Application Priority Data
Jun. 3, 2022 (JP) 2022-090792

(51) Int. Cl. G06T 7/73

(52) U.S. Cl. CPC G06T 7/74; G06T 2207/10032; G06T 2207/20081; G06T 2207/30244

(57) ABSTRACT

The projection diagram generation means 71 generates a projection diagram, which is a diagram obtained by projecting a three-dimensional shape of an object onto a two-dimensional plane along direction of a line of sight of a sensor of an artificial satellite. The pseudo-projection diagram generation means 72 generates a pseudo-projection diagram that represents the projection diagram in a pseudo way, based on a satellite image. The association means 73 associates points in the projection diagram with points in the pseudo-projection diagram. The mapping derivation means 74 derives a mapping that associates the point in the pseudo-projection diagram with points in the three-dimensional shape represented by the three-dimensional data, based on a result of association between the points in the projection diagram and the points in the pseudo-projection diagram.

### INCORPORATION BY REFERENCE

This application is based upon and claims the benefit of priority from Japanese patent application No. 2022-090792, filed on Jun. 3, 2022, the disclosure of which is incorporated herein in its entirety by reference.

### TECHNICAL FIELD

This invention relates to a position association system, a position association method, and a position association program that enable estimation of the three-dimensional coordinates of a subject in a satellite image.

### BACKGROUND ART

An image obtained by a sensor (a camera) installed in an artificial satellite taking an image is called a satellite image.

The following is a common technique for estimating the three-dimensional coordinates of a subject in a satellite image. That is, there is a technique for estimating the three-dimensional coordinates of a subject by estimating the point where the line of sight of the sensor at the time the subject was imaged intersects with the three-dimensional data of the subject. This technique is hereafter referred to as a line-of-sight intersection method.

PTL 1 describes an image processing device that includes a means for identifying a position in geographic information of an aerial image by matching extracted shape information with the geographic information.

PTL 2 describes generating a two-dimensional projection image while tracing the shooting position of a color line sensor on a 3D model.

NPL 1 describes pix2pix which is an example of image-to-image translations. pix2pix is an image-to-image translation technique based on deep learning. pix2pix can be regarded as an image-to-image translation model based on deep learning.

### CITATION LIST

### Patent Literature

PTL 1: Japanese Patent Application Laid-Open No. 2008-203991
PTL 2: Japanese Patent Application Laid-Open No. 2004-220516

### Non-Patent Literature

NPL 1: Phillip Isola, Jun-Yon Zhu, Tinghui Zhou, Alexei A. Efros, “Image-to-Image Translation with Conditional Adversarial Networks”, [online], [retrieved Apr. 25, 2022], Internet <URL: https://arxiv.org/pdf/1611.07004.pdf>

### SUMMARY

The example object of the present invention is to provide a position association system, a position association method, and a position association program that enable accurate estimation of the three-dimensional coordinates of a subject in a satellite image.

A position association system according to an example aspect of the invention includes a memory configured to store instructions; and a processor configured to execute the instructions to: generate a projection diagram, which is a diagram obtained by projecting a three-dimensional shape of an object onto a two-dimensional plane along direction of a line of sight of a sensor of an artificial satellite, based on three-dimensional data which is data representing the three-dimensional shape of the object and posture information indicating posture of the sensor when the sensor images the object; generate a pseudo-projection diagram that represents the projection diagram in a pseudo way, based on a satellite image obtained by the sensor imaging the object at the posture indicated by the posture information; associate points in the projection diagram with points in the pseudo-projection diagram; derive a mapping that associates the point in the pseudo-projection diagram with points in the three-dimensional shape represented by the three-dimensional data, based on a result of association between the points in the projection diagram and the points in the pseudo-projection diagram; and derive an association relation between points of object in the satellite image and the points in the three-dimensional shape represented by the three-dimensional data, based on the mapping.

A position association method according to an example aspect of the invention is implemented by a computer and comprises executing a projection diagram generation process of generating a projection diagram, which is a diagram obtained by projecting a three-dimensional shape of an object onto a two-dimensional plane along direction of a line of sight of a sensor of an artificial satellite, based on three-dimensional data which is data representing the three-dimensional shape of the object and posture information indicating posture of the sensor when the sensor images the object; executing a pseudo-projection diagram generation process of generating a pseudo-projection diagram that represents the projection diagram in a pseudo way, based on a satellite image obtained by the sensor imaging the object at the posture indicated by the posture information; executing an association process of associating points in the projection diagram with points in the pseudo-projection diagram; executing a mapping derivation process of deriving a mapping that associates the point in the pseudo-projection diagram with points in the three-dimensional shape represented by the three-dimensional data, based on a result of association between the points in the projection diagram and the points in the pseudo-projection diagram; and executing an association relation derivation process of deriving an association relation between points of object in the satellite image and the points in the three-dimensional shape represented by the three-dimensional data, based on the mapping.

A non-transitory computer-readable recording medium according to an example aspect of the invention is a non-transitory computer-readable recording medium in which a position association program is recorded, wherein the position association program causes a computer to execute: a projection diagram generation process of generating a projection diagram, which is a diagram obtained by projecting a three-dimensional shape of an object onto a two-dimensional plane along direction of a line of sight of a sensor of an artificial satellite, based on three-dimensional data which is data representing the three-dimensional shape of the object and posture information indicating posture of the sensor when the sensor images the object; a pseudo-projection diagram generation process of generating a pseudo-projection diagram that represents the projection diagram in a pseudo way, based on a satellite image obtained by the sensor imaging the object at the posture indicated by the posture information; an association process of associating points in the projection diagram with points in the pseudo-projection diagram; a mapping derivation process of deriving a mapping that associates the point in the pseudo-projection diagram with points in the three-dimensional shape represented by the three-dimensional data, based on a result of association between the points in the projection diagram and the points in the pseudo-projection diagram; and an association relation derivation process of deriving an association relation between points of object in the satellite image and the points in the three-dimensional shape represented by the three-dimensional data, based on the mapping.

### BRIEF DESCRIPTION OF THE DRAWINGS

FIG. 1 It depicts a block diagram showing an example configuration of a position association system of the example embodiment of the present invention.

FIG. 2 It depicts a schematic diagram showing an example of three-dimensional data.

FIG. 3 It depicts a schematic diagram showing schematically generation of the projection diagram.

FIG. 4 It depicts a schematic diagram showing an example of a satellite image.

FIG. 5 It depicts a schematic diagram showing schematically generation of pseudo-projection diagram.

FIG. 6 It depicts a schematic diagram showing an example of association between points in the projection diagram and points in the pseudo-projection diagram.

FIG. 7 It depicts a flowchart showing an example of the processing flow of the example embodiment of the invention.

FIG. 8 It depicts a schematic block diagram showing an example of computer configuration related to the position association system of the example embodiment of the present invention.

FIG. 9 It depicts a block diagram showing an overview of the position association system of the present invention.

### EXAMPLE EMBODIMENT

An example embodiment of the present invention is described below with reference to the drawings.

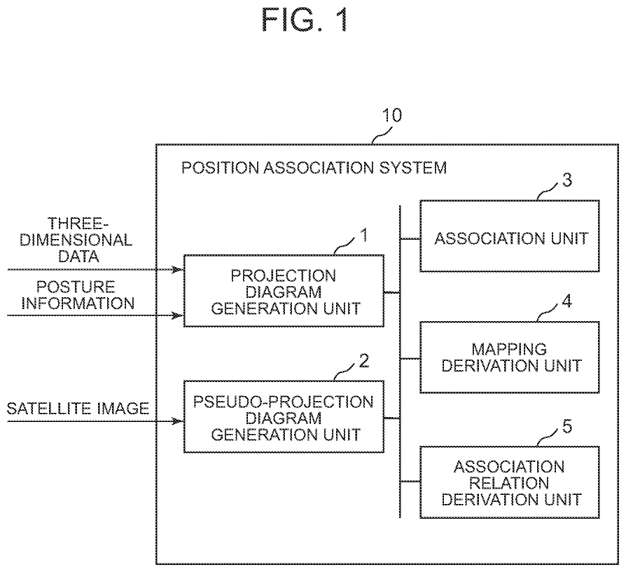

FIG. 1 is a block diagram showing an example configuration of a position association system of the example embodiment of the present invention. The position association system 10 of the present example embodiment includes a projection diagram generation unit 1, a pseudo-projection diagram generation unit 2, an association unit 3, a mapping derivation unit 4, and an association relation derivation unit 5.

Three-dimensional data and posture information indicating posture of a sensor (a camera) on an artificial satellite are input to the projection diagram generation unit 1.

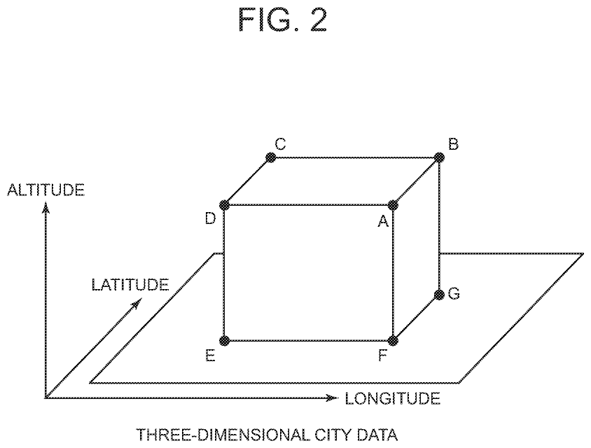

The three-dimensional data is data that represents the three-dimensional shape of an object on the ground. The three-dimensional data also includes information of the three-dimensional coordinates of the points (e.g., vertices, etc.) that define the three-dimensional shape. An example of the object is a structure in a city. Hereafter, the case where the object is a structure in a city will be used as an example, and the three-dimensional data will be referred to as three-dimensional city data. The object is the object to be imaged by the sensor of the artificial satellite. FIG. 2 is a schematic diagram showing an example of the three-dimensional data (the three-dimensional city data). The three-dimensional city data is generated in advance.

The posture information input to the projection diagram generation unit 1 is information indicating the posture of the sensor of the artificial satellite when it images the above object. The accuracy of the posture information input to the projection diagram generation unit 1 of the present example embodiment may be lower than the accuracy required for the posture information by the line-of-sight intersection method.

The reason for this is that when the line-of-sight intersection method is used, the accuracy of the posture information is directly related to the accuracy of the three-dimensional position estimation, but in the position association system 10 of the present example embodiment, the association unit 3 performs matching by image matching. Therefore, instead of real data (e.g., the posture information at the time of imaging), as posture information, an approximation of the real data may be input to the projection diagram generation unit 1.

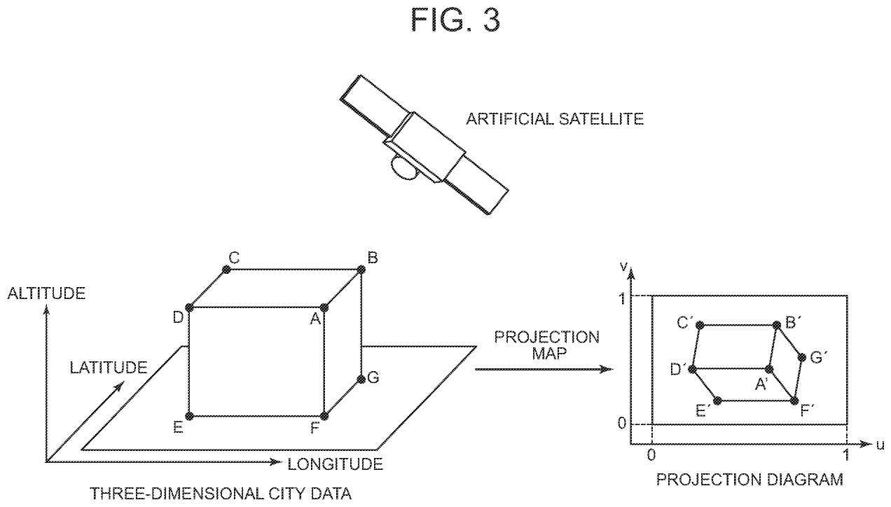

Based on the input three-dimensional data and the posture information, the projection diagram generation unit 1 generates a projection diagram, which is a diagram obtained by projecting the three-dimensional shape represented by the three-dimensional city data onto a two-dimensional plane along the direction of the line of sight of the sensor. FIG. 3 is a schematic diagram showing schematically generation of the projection diagram by the projection diagram generation unit 1. In FIG. 3, points A′, B′, C′, D′, E′, F′, G′, . . . in the projection diagram are associated with points A, B, C, D, E, F, G, . . . in the three-dimensional shape represented by the three-dimensional city data.

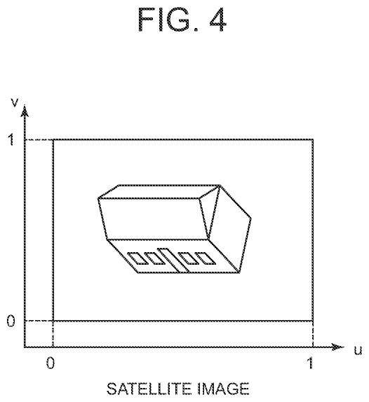

The satellite image obtained by the sensor imaging the above object at the posture indicated by the posture information input to the projection diagram generation unit 1 is input to the pseudo-projection diagram generation unit 2. FIG. 4 is a schematic diagram showing an example of a satellite image.

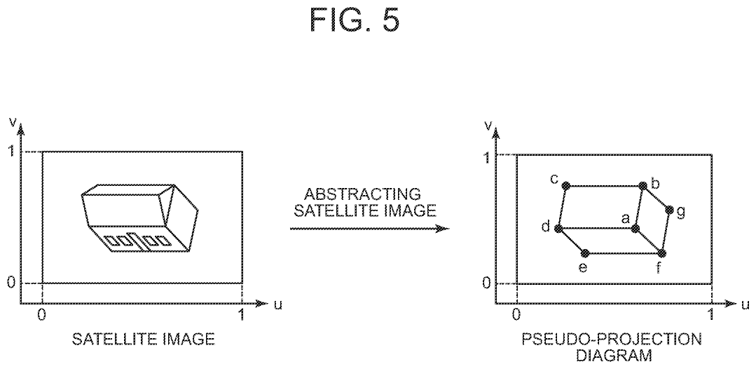

The pseudo-projection diagram generation unit 2 generates a pseudo-projection diagram that represents, in a pseudo way, the projection diagram (the projection diagram generated by the projection diagram generation unit 1, see FIG. 3) based on the input satellite image. FIG. 5 is a schematic diagram showing schematically generation of the pseudo-projection diagram by the pseudo-projection diagram generation unit 2.

The pseudo-projection diagram generation unit 2 generates the pseudo-projection diagram by performing an image-to-image translation on the satellite image and abstracting the satellite image through the image-to-image translation. The pseudo-projection diagram generation unit 2 uses, for example, pix2pix as an image-to-image translation model.

Specifically, the image-to-image translation is a technique for transforming the type of information represented in an image. For example, generating a color image from a monochrome image falls under the image-to-image translation. On the other hand, the transformation of image data format (e.g., transformation from a PNG (Portable Network Graphics) image to a JPEG (Joint Photographic Experts Group) image) does not change the information represented in the image. Accordingly, the transformation of image data format does not fall under the image-to-image translation.

Abstracting a satellite image means capturing the geometric features of the subject in the satellite image and representing the subject in the satellite image by a combination of simple polygons. In the present example embodiment, the pseudo-projection diagram generation unit 2 performs an image-to-image translation to abstract the satellite image.

The image-to-image translation model used for the image-to-image translation is pre-trained (in other words, pre-learned) to be able to represent the projection diagram in a pseudo way based on the satellite image. When pix2pix is used by the pseudo-projection diagram generation unit 2, a generator generates a pseudo-projection diagram consisting of a large number of polygons at the time of training. A discriminator then determines the authenticity of the pseudo-projection diagram generated by the generator and the correct image (the image of the corresponding three-dimensional shape). By repeating such a process, the generator is able to generate a pseudo-projection diagram that is close to the correct image.

By being provided the pseudo-projection diagram generation unit 2, the position association system 10 of the present example embodiment can perform association independent of the imaging specifications of the satellite image (e.g., imaging wavelength, exposure time, and other characteristics specific to the satellite).

In other words, the position association system 10 of the present example embodiment, which employs the image-to-image translation, has advantages over general position association systems. A general position association system, for example, is a system that generates a projection diagram of exterior textured three-dimensional data onto a two-dimensional plane (textured projection diagram) by means similar to the projection diagram generation unit 1, and associates points in the textured projection diagram with points in the satellite image by means similar to the association unit 3.

In principle, the general position association system can estimate three-dimensional coordinates with high accuracy using the line-of-sight intersection method without the pseudo-projection diagram generation unit 2 of the present example embodiment. However, the estimation accuracy of the general position association system is inferior to that of the position association system 10 of the present example embodiment because it strongly depends on the similarity between the textured projection diagram and the satellite image.

For example, when the exterior texture of the three-dimensional data is a visible image and the satellite image is an infrared image, the general position association system is not expected to estimate three-dimensional coordinates with high accuracy. Since the position association system 10 of the present example embodiment employs the image-to-image translation, it can estimate three-dimensional coordinates with high accuracy without using the exterior texture of the three-dimensional data.

The association unit 3 associates points in the projection diagram (see FIG. 3) with points in the pseudo-projection diagram (see FIG. 5). In other words, the association unit 3 performs two-dimensional image matching with respect to the projection diagram and the pseudo-projection diagram. The association unit 3 may associate the points in the projection diagram with the points in the pseudo-projection diagram using known techniques.

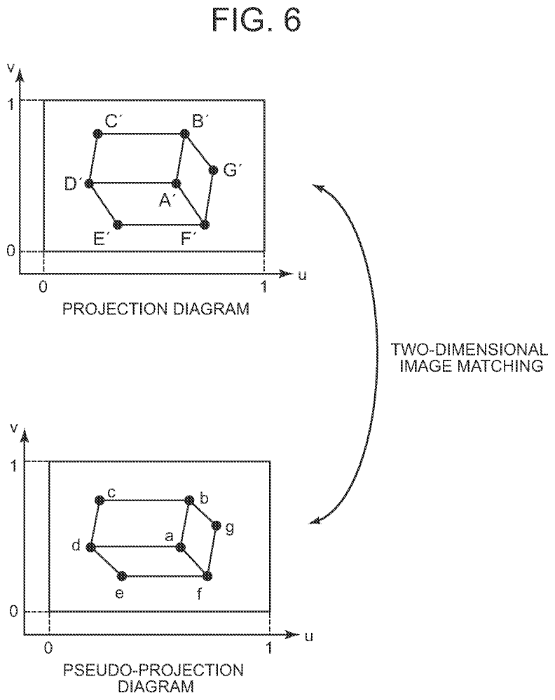

FIG. 6 is a schematic diagram showing an example of the association between the points in the projection diagram and the points in the pseudo-projection diagram. In this example, the association unit 3 associates points A′, B′, C′, D′, E′, F′, G′, . . . in the projection diagram with the points a, b, c, d, e, f, g, . . . in the pseudo-projection diagram.

The mapping derivation unit 4 derives a mapping that associates the points in the pseudo-projection diagram with the points in the three-dimensional shape represented by the three-dimensional city data based on the result of the association between the points in the projection diagram and the points in the pseudo-projection diagram by the association unit 3. In this example, the mapping derivation unit 4 derives a mapping that associates the points a, b, c, d, e, f, g, . . . in the pseudo-projection diagram shown in FIG. 6 with the points A, B, C, D, E, F, G, . . . in the three-dimensional shape represented by the three-dimensional city data (see FIG. 2).

The association relation derivation unit 5 derives the association relation between points of the object (the subject) in the satellite image (see FIG. 4) and the points in the three-dimensional shape represented by the three-dimensional city data (see FIG. 2) based on the mapping derived by the mapping derivation unit 4.

Therefore, it can be said that the position association system 10 associates the points of objects in the satellite image with the points in the three-dimensional shape represented by the three-dimensional city data. As a result, the three-dimensional coordinates associated with the points of the object (the subject) in the satellite image can be estimated.

The projection diagram generation unit 1, the pseudo-projection diagram generation unit 2, the association unit 3, the mapping derivation unit 4, and the association relation derivation unit 5 are realized, for example, by a CPU (Central Processing Unit) of a computer operating according to a position association program. For example, the CPU may read the position association program from a program recording medium, such as a program storage device of the computer, and operate as the projection diagram generation unit 1, the pseudo-projection diagram generation unit 2, the association unit 3, the mapping derivation unit 4, and the association relation derivation unit 5 according to the position association program.

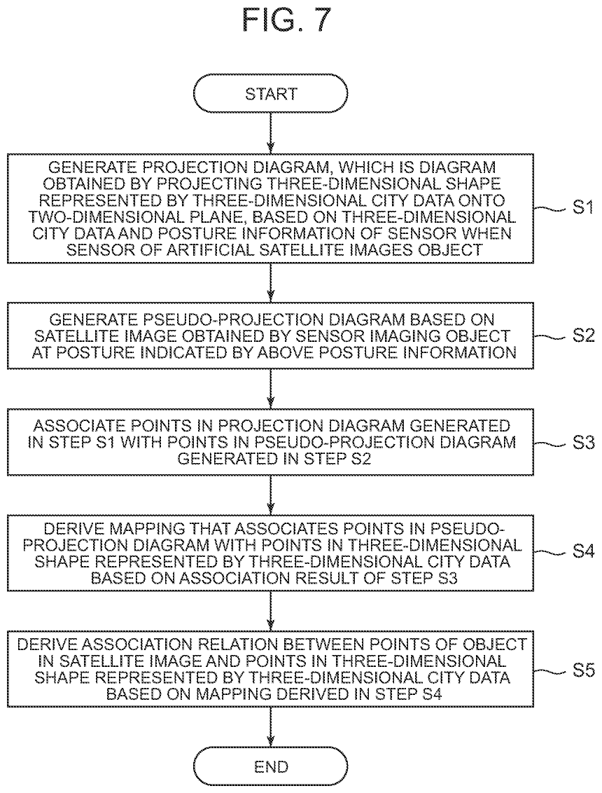

Next, the processing flow is described. FIG. 7 is a flowchart showing an example of the processing flow of the example embodiment of the invention. Matters that have already been explained are omitted.

First, the projection diagram generation unit 1 generates a projection diagram, which is a diagram obtained by projecting the three-dimensional shape represented by the three-dimensional city data onto a two-dimensional plane along the direction of the line of sight of the sensor, based on the three-dimensional city data and the posture information of the sensor when the sensor of the artificial satellite images the object (step S1).

Next, the pseudo-projection diagram generation unit 2 generates a pseudo-projection diagram based on the satellite image obtained by the sensor imaging the object at the posture indicated by the above posture information (step S2).

Next, the association unit 3 associates the points in the projection diagram generated in step S1 with the points in the pseudo-projection diagram generated in step S2 (step S3).

Next, the mapping derivation unit 4 derives a mapping that associates the points in the pseudo-projection diagram with the points in the three-dimensional shape represented by the three-dimensional city data based on the association result of step S3 (step S4).

Next, the association relation derivation unit 5 derives the association relation between the points of the object in the satellite image and the points in the three-dimensional shape represented by the three-dimensional city data based on the mapping derived in step S4 (step S5).

In the present example embodiment, as described above, the association relation between the points of the object in the satellite image and the points in the three-dimensional shape represented by the three-dimensional city data is derived. Thus, the three-dimensional coordinates of the object (the subject) in the satellite image can be estimated.

Here, the association between the points in the projection diagram and the points in the pseudo-projection diagram (step S3) can be performed with high accuracy, and the result of the association between the points in the projection diagram and the points in the pseudo-projection diagram is highly accurate. In the present example embodiment, the mapping derivation unit 4 derives the mapping based on the result of such a highly accurate association (step S4). Furthermore, based on the mapping, the association relation derivation unit 5 derives the association relation between the points of the object in the satellite image and the points in the three-dimensional shape represented by the three-dimensional city data. Thus, the three-dimensional coordinates of the object (the subject) in the satellite image can be accurately estimated.

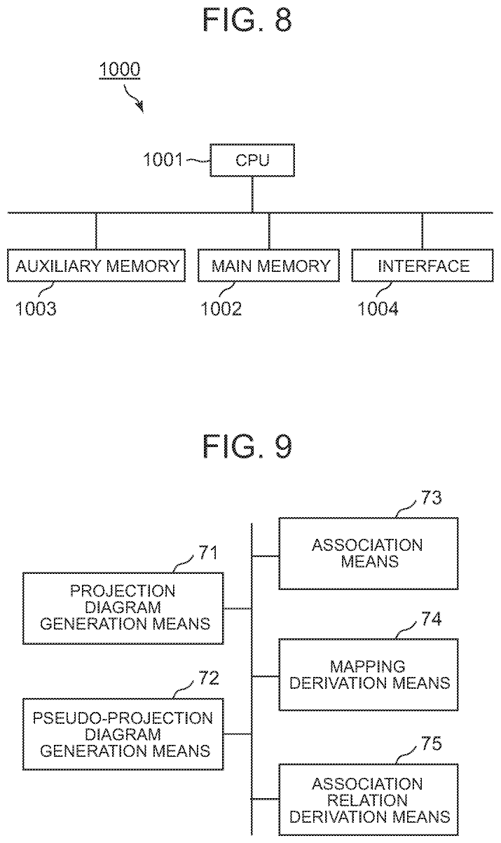

FIG. 8 is a schematic block diagram showing an example of computer configuration related to the position association system 10 of the example embodiment of the present invention. The computer 1000 includes a CPU 1001, a main memory 1002, an auxiliary memory 1003, and an interface 1004.

The position association system 10 of the example embodiment of the present invention is realized by a computer 1000. The operation of the position association system 10 is stored in the auxiliary memory 1003 in the form of a position association program. The CPU 1001 reads the position association program from the auxiliary memory 1003, expands the position association program in the main memory 1002, and executes the process described in the above example embodiment according to the position association program.

The auxiliary memory 1003 is an example of a non-transitory tangible medium. Other examples of non-transitory tangible media include magnetic disks, magneto-optical disks, CD-ROM (Compact Disk Read Only Memory), DVD-ROM (Digital Versatile Disk Read Only Memory), semiconductor memory, etc., connected via interface 1004. When the program is delivered to the computer 1000 through a communication line, the computer 1000 receiving the delivery may expand the program in the main memory 1002 and execute the process described in the above example embodiment according to the program.

Some or all of the components may be realized by general-purpose or dedicated circuitry, processor, or a combination of these. These may comprise a single chip or multiple chips connected via a bus. Some or all of the components may be realized by a combination of the above-mentioned circuitry, etc. and a program.

When some or all of components are realized by multiple information processing devices, circuits, etc., the multiple information processing devices, circuits, etc. may be centrally located or distributed. For example, the information processing devices and circuits may be realized as a client-and-server system, a cloud computing system, etc., each of which is connected via a communication network.

The following is an overview of the invention. FIG. 9 is a block diagram showing an overview of the position association system of the present invention. The position association system of the present invention includes projection diagram generation means 71, pseudo-projection diagram generation means 72, association means 73, mapping derivation means 74, and association relation derivation means 75.

The projection diagram generation means 71 (e.g., the projection diagram generation unit 1) generates a projection diagram, which is a diagram obtained by projecting a three-dimensional shape of an object onto a two-dimensional plane along direction of a line of sight of a sensor of an artificial satellite, based on three-dimensional data which is data representing the three-dimensional shape of the object and posture information indicating posture of the sensor when the sensor images the object.

The pseudo-projection diagram generation means 72 (e.g., the pseudo-projection diagram generation unit 2) generates a pseudo-projection diagram that represents the projection diagram in a pseudo way, based on a satellite image obtained by the sensor imaging the object at the posture indicated by the posture information.

The association means 73 (e.g., the association unit 3) associates points in the projection diagram with points in the pseudo-projection diagram.

The mapping derivation means 74 (e.g., the mapping derivation unit 4) derives a mapping that associates the point in the pseudo-projection diagram with points in the three-dimensional shape represented by the three-dimensional data, based on a result of association between the points in the projection diagram and the points in the pseudo-projection diagram.

The association relation derivation means 75 (e.g., association relation derivation unit 5) derives an association relation between points of object in the satellite image and the points in the three-dimensional shape represented by the three-dimensional data, based on the mapping.

According to such a configuration, the three-dimensional coordinates of the subject in the satellite image can be accurately estimated.

The pseudo-projection diagram generation means 72 may generate the pseudo-projection diagram by performing an image-to-image translation on the satellite image.

The pseudo-projection diagram generation means 72 may perform the image-to-image translation using an image-to-image translation model based on deep learning.

The pseudo-projection diagram generation means 72 may generate a subject in abstracted satellite image by the image-to-image translation.

In the line-of-sight intersection method, the accuracy of estimating the three-dimensional coordinates of the subject depends on position information and posture information of the sensor and geographic information accuracy and resolution (Level of Detail) of the three-dimensional data. However, each of these pieces of information has a large degree of uncertainty, making it difficult to improve the accuracy of estimating the three-dimensional coordinates of the subject.

According to the present invention, the three-dimensional coordinates of the subject in the satellite image can be accurately estimated.

The invention is suitably applied to a system for deriving association relation between points of an object (a subject) in a satellite image and points in a three-dimensional shape represented by three-dimensional data.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

1 Projection diagram generation unit
2 Pseudo-projection diagram generation unit
3 Association unit
4 Mapping derivation unit
5 Association relation derivation unit
10 Position association system

What is claimed is:

1. A position association system comprising:
a memory configured to store instructions; and
a processor configured to execute the instructions to:
generate a projection diagram, which is a diagram obtained by projecting a three-dimensional shape of an object onto a two-dimensional plane along direction of a line of sight of a sensor of an artificial satellite, based on three-dimensional data which is data representing the three-dimensional shape of the object and posture information indicating posture of the sensor when the sensor images the object;
generate a pseudo-projection diagram that represents the projection diagram in a pseudo way, based on a satellite image obtained by the sensor imaging the object at the posture indicated by the posture information;
associate points in the projection diagram with points in the pseudo-projection diagram;
derive a mapping that associates the point in the pseudo-projection diagram with points in the three-dimensional shape represented by the three-dimensional data, based on a result of association between the points in the projection diagram and the points in the pseudo-projection diagram; and
derive an association relation between points of object in the satellite image and the points in the three-dimensional shape represented by the three-dimensional data, based on the mapping.

2. The position association system according to claim 1, wherein
the processor generates the pseudo-projection diagram by performing an image-to-image translation on the satellite image.

3. The position association system according to claim 2, wherein
the processor performs the image-to-image translation using an image-to-image translation model based on deep learning.

4. The position association system according to claim 3, wherein
the processor generates a subject in abstracted satellite image by the image-to-image translation.

5. A position association method, implemented by a computer, comprising:
executing a projection diagram generation process of generating a projection diagram, which is a diagram obtained by projecting a three-dimensional shape of an object onto a two-dimensional plane along direction of a line of sight of a sensor of an artificial satellite, based on three-dimensional data which is data representing the three-dimensional shape of the object and posture information indicating posture of the sensor when the sensor images the object;
executing a pseudo-projection diagram generation process of generating a pseudo-projection diagram that represents the projection diagram in a pseudo way, based on a satellite image obtained by the sensor imaging the object at the posture indicated by the posture information;
executing an association process of associating points in the projection diagram with points in the pseudo-projection diagram;
executing a mapping derivation process of deriving a mapping that associates the point in the pseudo-projection diagram with points in the three-dimensional shape represented by the three-dimensional data, based on a result of association between the points in the projection diagram and the points in the pseudo-projection diagram; and
executing an association relation derivation process of deriving an association relation between points of object in the satellite image and the points in the three-dimensional shape represented by the three-dimensional data, based on the mapping.

6. The position association method according to claim 5, wherein
in the pseudo-projection diagram generation process, the computer generates the pseudo-projection diagram by performing an image-to-image translation on the satellite image.

7. A non-transitory computer-readable recording medium in which a position association program is recorded, wherein the position association program causes a computer to execute:
a projection diagram generation process of generating a projection diagram, which is a diagram obtained by projecting a three-dimensional shape of an object onto a two-dimensional plane along direction of a line of sight of a sensor of an artificial satellite, based on three-dimensional data which is data representing the three-dimensional shape of the object and posture information indicating posture of the sensor when the sensor images the object;
a pseudo-projection diagram generation process of generating a pseudo-projection diagram that represents the projection diagram in a pseudo way, based on a satellite image obtained by the sensor imaging the object at the posture indicated by the posture information;
an association process of associating points in the projection diagram with points in the pseudo-projection diagram;
a mapping derivation process of deriving a mapping that associates the point in the pseudo-projection diagram with points in the three-dimensional shape represented by the three-dimensional data, based on a result of association between the points in the projection diagram and the points in the pseudo-projection diagram; and
an association relation derivation process of deriving an association relation between points of object in the satellite image and the points in the three-dimensional shape represented by the three-dimensional data, based on the mapping.

8. The non-transitory computer-readable recording medium according to claim 7,
wherein the position association program causes the computer to execute:
generating the pseudo-projection diagram by performing an image-to-image translation on the satellite image, in the pseudo-projection diagram generation process.
